(19) United States
(12) Patent Application Publication
(10) Pub. No.: US 2006/0253308 A1
(43) Pub. Date: Nov. 9, 2006

(54) Method of marketing for the airline transportation industry

(76) Inventor: Richard` M. Knauer, Highland Park, NJ (US)

Correspondence Address: Mr. Walter J. Tencza Jr., Suite 3, 10 Station Place, Metuchen, NJ, 08840, US

(21) Appl. No.: 11/124,780

(22) Filed: May 9, 2005

(51) Int. Cl. G06Q 10/00

(52) U.S. Cl. 705/5

(57) ABSTRACT

A method for providing airplane transportation service is disclosed. A customer is allowed to purchase a first number of flight units, which can be used on any one of a group of airlines. A customer flight request is received to depart a particular airport at a particular time, on a particular day, for a particular destination. It is determined if the first number of flight units is greater than an anticipated number of flight units for a typical flight departing from the particular airport for the particular destination. The customer is booked on a first flight of a plurality of flights if the first number of flight units is greater than or equal to the anticipated number of flight units for the typical flight, wherein the first flight is closest in time of the plurality of flights to the particular time specified by the customer flight request.

### FIELD OF THE INVENTION

This invention relates to improved methods and apparatus concerning marketing for the airline industry.

### BACKGROUND OF THE INVENTION

The sales, marketing, and distribution of air travel services have traditionally been handled through a distribution system comprising many different outlets for the sale of tickets, typically for individual flights, to consumers. The distribution network typically consists of direct sales, typically of individual tickets for individual flights, from the airlines to the purchaser. Tickets for individual flights may also be sold through travel agents, or wholesalers who provide package deals to large groups in co-operation with hotels, casinos, convention centers, or cities, etc. A relative newcomer in this mix is the Internet and on-line booking of air travel.

The financial problems that the airline industry has been experiencing is largely due to unprofitable revenue. High fuel costs are the most visible of their recent problems. Complex and expensive marketing and pricing strategies involving expensive hardware, software, and labor, and do nothing to enhance profitable revenue. These complex expensive marketing and pricing strategies increase ruinous price competition among airlines. Add to this mix poor management and costly employee contracts negotiated in a deregulated environment that management and employees both knew were not affordable.

Industry financial problems go back to the late 70's when deregulation took effect. Many airline carriers went bankrupt or liquidated, including Eastern (trademarked), Pam Am (trademarked), Braniff (trademarked), and People (trademarked).

In a well functioning fluid commodities market the prices are determined by many factors, including supply and demand, investor sentiment, speculation, etc. All of which leaves a great deal of uncertainty when your seat prices have a bottom line, below which producers of a commodity lose money due to the costs inherent in delivering in this marketplace. Except for Southwest Airlines, they have not even been successful in hedging their fuel usage. Farmers and other producers of commodities have successfully used these methods for 150 years.

U.S. Published Patent Application No. 20040236597, to Brody, titled “Method of Capacity Marketing”, filed Mar. 3, 2004, discloses a method for marketing air travel services. The method includes purchasing a capacity unit corresponding to a fixed distance of air travel for a passenger on an airline carrier. The capacity unit is sold as a commodity unit in a commodity market.

### SUMMARY OF THE INVENTION

The present invention in one or more embodiments provides a method of providing airplane transportation service, typically on one or more commercial airlines. The method may include allowing a customer to purchase a first number of flight units, which can be used on any one of a group of airlines. The method may further include receiving a customer flight request to depart a particular airport at a particular time, on a particular day, for a particular destination. Based solely on this information a flight can be reserved for a customer immediately. The method may also include determining if the first number of flight units is greater than an anticipated number of flight units for a typical flight departing from the particular airport for the particular destination, wherein the group of airlines offers a plurality of flights on the particular day to the particular destination. The method also may further be further comprised of booking the customer on a first flight of the plurality of flights if the first number of flight units is greater than or equal to the anticipated number of flight units for the typical flight, wherein the first flight is the closest in time of the plurality of flights to the particular time specified by the customer flight request.

A classification may be determined for the customer. One or more additional services relating to the first flight may be provided, if the classification of the customer is first class premium. The one or more additional services may relate to special baggage handling or to an amount of advance notice required to book a flight time. The customer may only be allowed to book the first flight, if the first number of flight units were purchased less than a time period prior to the first flight. The time period may be about one year or about six months.

The flight units may be, for example, hours or miles.

The present invention also provides a computer processor, which receives a customer flight request to depart a particular airport at a particular time, on a particular day, for a particular destination. The flight request may be received via telephone or over the Internet, for example. The computer processor determines if a first number of flight units purchased by a customer is greater than an anticipated number of flight units for a typical flight departing from the particular airport for the particular destination. The computer processor books the customer on a first flight of the plurality of flights if the first number of flight units is greater than or equal to the anticipated number of flight units for the typical flight, wherein the first flight is closest in time of the plurality of flights to the particular time specified by the customer flight request.

### BRIEF DESCRIPTION OF THE DRAWINGS

FIG. 1 shows a flow chart of a method in accordance with an embodiment of the present invention.

### DETAILED DESCRIPTION OF THE DRAWINGS

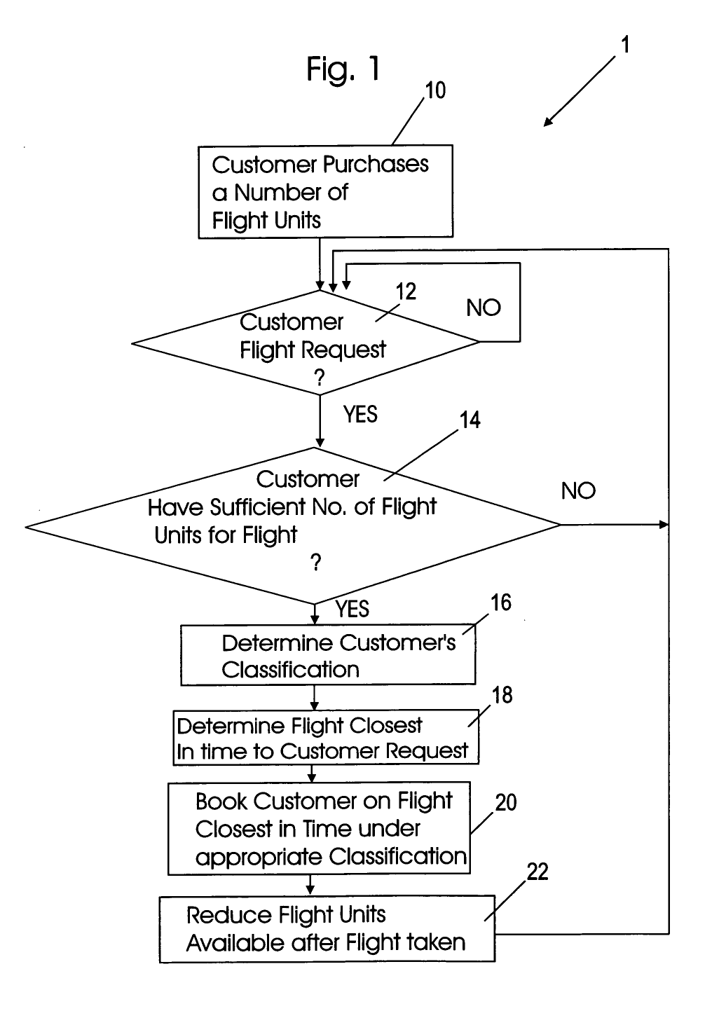

FIG. 1 shows a flow chart 1 of a method in accordance with an embodiment of the present invention. At step 10, a customer purchases a number of flight units such as hours or miles of flight of airline travel. The flight units typically may be used on any airline of a group of airlines that participate in the method or program.

At step 12, the method determines whether the customer has made a flight request to fly on a specific airline flight. A computer processor may make this determination after receiving a flight request by telephone or via the Internet. For example, the customer may request to take a flight number 455 departing Newark, N.J. International Airport at 9:00 a.m. and arriving at Orlando, Fla. Airport at 10:30 a.m. on Feb. 19, 2006. However, in at least one embodiment, the customer may provide his or her destination, the airport he or she wants to leave from, and the time of departure. This can be done by telephone through one central telephone number. This information can be fed into a computer processor or system and the computer processor or system may select the flight leaving closest in time to the customer's desired departure preference. The closest flight in time may be selected by a computer processor or computer system from a plurality of flights offered by a group of participating commercial airlines. The plurality of flights may all leave the particular airport on the particular day.

At step 14, the method or computer processor determines whether the customer has a sufficient number of flight units left for the specific flight, such as flight number 455. If the customer has a sufficient number of flight units left, the method or computer processor next determines the customer's classification at step 16. The customer may, for example, be classified as a coach customer or as a first class customer. A first class customer may receive benefits or amenities, which a coach customer may not receive. The step 16 may take place prior to step 14.

At step 18, the computer processor or method may determine the flight closest in time to the departure time provided in the flight request by the customer. At step 20 the computer processor may book the customer on the flight, closest in time under the appropriate classification. At step 22 the number of flight units such as hours or miles available is reduced after the flight is booked or after the flight is taken.

The present invention in one or more embodiments, allows the airline industry to substantially reduce marketing costs (related to competitive pricing of their services via other airlines) along with the unprofitable, ruinous competition in which they currently operate. The use of the present invention will save airlines tens of millions of dollars annually in employee wages, and other expenses related to the current method in which they market their product. The use of the present invention, in one or more embodiments will allow the airlines to increase profits received from the sale of airline seats on their existing flights.

Typically the customer may use his or her flight units to fly on any airline that participates in the method or program. The flight units may be purchased on an annual or bi-annual basis. For example, an individual may purchase two hundred flight units to be used within one calendar year, such as 2005.

The present invention, in one or more embodiments, can be used to reduce the marketing costs related to the pricing of tickets on hundreds of airline routes. The present invention may also be used to reduce the predatory pricing between airline companies.

The airlines, not a commodities or futures market, determines the price of a number of flight units for a single passenger seat on an airline carrier. The classifications of customers provided may include two classifications or classes of customers who would purchase tickets according to the number of flight units that they determine they fly on for example an annual (or bi-annual) basis.

It is an object of the present invention to provide the customers of this program with a level of service that enhances their flying experience. It is a further object of the present invention to eliminate the workload involved in booking reservations and comparing price among carriers.

It is an object of the present invention to have at least several participating airlines, so that the customer or purchaser of an annual or bi-annual block of hourly units or miles has many different flights available to hundreds of destinations (domestically and internationally) on a daily basis.

The classifications of customers provided may include first class premium and coach. The first class premium customers may receive various amenities. In one embodiment, the first class premium customers with a two hundred or more annual flight units (such as hours) purchased can be boarded in most instances with a four hour (or less) notification on most domestic flights. On international routes three days notification or less may be provided. On certain holidays to heavily traveled destinations, such as to popular vacation destinations, or on popular holidays such as Thanksgiving, Christmas, Easter, additional time to book reservations may be required.

The customers or passengers may be classified into two main flying classifications: coach and first class premium. Coach may include leisure, corporate, and (business) economy. First class premium may include premium corporate (business) leisure etc. The Tickets for the two classifications of travel may be purchased for a certain number of hours for a year or ½ a year. For example, two hundred flight units (or hours) for the year 2005, or fifty flight units or hours for ½ year. The unused hours may be carried over into the following year or same year with the additional purchase of hours equaling the hours purchased previously.

The purchasers of two hundred units (or hours) under the classification of first class premium may receive an additional twenty-five units (or hours) of flying time. Customers will be willing to pay for flight units (such as hours or miles) due to the convenience and other amenities, which they would enjoy.

The present invention provides the financially beleaguered airline industry with a more efficient marketing method resulting in increased profitability for participating airlines. Participating airlines will save Tens of millions by avoiding wasteful competition involving pricing via the competition on hundreds of routes.

A clearing house, such as a computer processor, can be used to keep tract of the flight units (such as hours or miles) used by customers of the participating airlines and to credit and debit customers accounts; while handing any additional promotions, travel related issues or spin-offs related to this service.

The present invention, in one or more embodiments differs from other proposed marketing endeavors which rely on commodities and futures based market proposals; in which airlines are at the whims of supply and demand and the strong possibility that their tickets would sell for less than the price it takes to produce the product. In the present invention, generally, the airlines are in control of the market for this premium service. It is the airlines and the consumer or customer who collectively decide what the hourly rate should be for the classes of travel offered.

If the consumer, generally, desires the program the airlines and users will decide in monetary terms if the monetary value of the amenities being offered are worth the additional costs. Generally, there will be no speculators, resellers, only the actual users of the services that the airlines provide. Yet in the end if the participants decide they want to open the system up to others they may do so.

Flight units will be interchangeable among participating carriers. This process enables the holders of these flight units (such as hourly air units or miles) to avoid the aggravation of trying to competitively price their tickets among many airlines trying to obtain best price.

It is understood that there are other ways that airlines may sell or price their seats other than using the length of the flight. For example, minimum charges may be established for short flights. If anticipated flight time is under a half hour, the passenger would be required to pay a minimum half hour charge. All flight hours typically are a known quantity prior to flight so are the miles flown. Debiting of the miles or hours can be done prior to the customer taking the flight when the booking of the flight is done.

Another means of determining the price of a flight would be using the standard airline cost basis of “seat miles” flown. The airline would sell miles and customers would make purchases based on the total number of miles they expect to fly.

The first class premium customers may receive further amenities, including special baggage handling and full course meals. The level of services with amenities (such as full course meals) may be available on every flight of one hour or more.

In the present invention, in on or more embodiments, first class premium customers may enjoy most of the amenities and ease of travel that only owners of large corporate jets such as Gulfstream (trademarked), Candair Challenger (trademarked), and Falcon (trademarked)) currently enjoy. In the prior art, a ¼ fractional ownership of a corporate jet can cost up to eight million U.S. dollars plus a twenty-five thousand dollar a month maintenance fees. Additionally you are paying up to 5,000 dollars per hour for every hour of flying time. For a fraction of the cost of corporate jet ownership, the present invention allows a person to fly in a first class cabin that is larger than a corporate jet cabin for example, on flights of ½ hour or more non-stop to almost any destination they do with reasonable prior notification requested for travel on most flights.

The present invention will allow the participating airlines to enjoy a profitable cash flow that will boost the equity value of their shares. Corporations, individuals, families, with college students, government, current fractional owners of jets etc., will be customers.

Passengers who fly 25 hours or more annually or biannually may simply purchase 25 hours of flying time, in accordance with an embodiment of the present invention, instead of individual tickets. The passengers or customers using the present invention may be checked by using fingerprint, eye, and/or facial recognition technologies as well as hologram and picture identification information. The identification for customers or passengers of the present invention may be encrypted and stored in a secure database.

Tens of thousands of seats to hundreds of destinations leaving from over a hundred airports each day can be available to a customer holding a block of flight hours or a block of flight miles. The holder of a block of flight hours or miles can board an airplane without the purchase of an individual trip ticket.

Although the invention has been described by reference to particular illustrative embodiments thereof, many changes and modifications of the invention may become apparent to those skilled in the art without departing from the spirit and scope of the invention. It is therefore intended to include within this patent all such changes and modifications as may reasonably and properly be included within the scope of the present invention's contribution to the art.

I claim:

1. A method of providing airplane transportation service comprising the steps of
allowing a customer to purchase a first number of flight units, which can be used, on any one of a group of airlines;
receiving a customer flight request to depart a particular airport at a particular time, on a particular day, for a particular destination;
determining if the first number of flight units is greater than an anticipated number of flight units for a typical flight departing from the particular airport for the particular destination;
wherein the group of airlines offers a plurality of flights on the particular day to the particular destination; and
further comprising booking the customer on a first flight of the plurality of flights if the first number of flight units is greater than or equal to the anticipated number of flight units for the typical flight, wherein the first flight is closest in time of the plurality of flights to the particular time specified by the customer flight request.

2. The method of claim 1 further comprising
determining a classification of the customer; and
providing one or more additional services relating to the first flight if the classification of the customer is first class premium.

3. The method of claim 2 wherein
the one or more additional services include providing special baggage handling.

4. The method of claim 2 wherein
the one or more additional services relate to an amount of advance notice required to book a flight time.

5. The method of claim 1 further comprising
determining when the first number of flight units were purchased; and
allowing the customer to book the first flight only if the first number of flight units were purchased less than a time period prior to the first flight.

6. The method of claim 5 wherein
the time period is about one year.

7. The method of claim 5 wherein
the time period is about six months.

8. The method of claim 1 wherein
the flight units are miles.

9. The method of claim 1 wherein
the flight units are hours.

10. An apparatus comprising
a computer processor which
receives a customer flight request to depart a particular airport at a particular time, on a particular day, for a particular destination; and
determines if a first number of flight units purchased by a customer is greater than an anticipated number of flight units for a typical flight departing from the particular airport for the particular destination; and
wherein the first number of flight units can be used on any one of a group of airlines,
wherein the group of airlines offers a plurality of flights on the particular day to the particular destination; and
further wherein the computer processor books the customer on a first flight of the plurality of flights if the first number of flight units is greater than or equal to the anticipated number of flight units for the typical flight, wherein the first flight is closest in time of the plurality of flights to the particular time specified by the customer flight request.

11. The apparatus of claim 10 wherein
the computer processor determines a classification of the customer.

12. The apparatus of claim 10 wherein
the computer processor determines when the first number of flight units were purchased; and books the first flight for the customer only if the first number of flight units were purchased less than a time period prior to the first flight.

13. The apparatus of claim 12 wherein
the time period is about one year.

14. The apparatus of claim 12 wherein
the time period is about six months.

15. The apparatus of claim 10 wherein
the flight units are miles.

16. The apparatus of claim 10 wherein
the flight units are hours.
